(19) United States
(12) Patent Application Publication
(10) Pub. No.: US 2008/0026112 A1
(43) Pub. Date: Jan. 31, 2008

(54) Multilayer Tube for Transfer of Smoke Curing Solution to Food

(75) Inventors: Nobuyuki Mori, Kanagawa (JP); Ichiro Arai, Kanagawa (JP)

Correspondence Address: POSZ LAW GROUP, PLC, 12040 SOUTH LAKES DRIVE, SUITE 101, RESTON, VA, 20191, US

(73) Assignees: GUNZE LIMITED, Kyoto (JP); GUNZE KOUBUNSHI CORPORATION, kanagawa (JP)

(21) Appl. No.: 10/578,684

(22) PCT Filed: Nov. 12, 2004
(86) PCT No.: PCT/JP04/17208

§ 371 Date: Mar. 29, 2007

(30) Foreign Application Priority Data
Nov. 12, 2003 (JP) 2003-382867

(51) Int. Cl. B65D 85/00; A47J 43/00

(52) U.S. Cl. 426/106; 99/534

(57) ABSTRACT

The present invention provides a multilayer tube for transferring a smoke-curing liquid to food, in which the tube has an innermost layer comprising a polyamide resin and a crosslinked polyvinylpyrrolidone; a packaged food product, in which the food product has been packaged in the multilayer tube for transferring a smoke-curing liquid to food; and a method for producing a smoked food using the multilayer tube for transferring a smoke-curing liquid to food.

### TECHNICAL FIELD

The present invention relates to a multilayer tube for transferring a smoke-curing liquid to food, such as meat and the like, i.e., multilayer tube for transferring smoke-curing liquid to food.

### BACKGROUND OF THE INVENTION

Heretofore, food products such as meat, cheese, and the like have been smoke-cured by being actually exposed to smoke while being packaged in natural casings, such as intestines or the like of animals, fibrous casings mainly comprising viscose as a starting material, collagen casings comprising collagen as a starting material, etc.

This method, however, poses problems in that since most of the smoke is emitted to the atmosphere, the smoke-curing efficiency is low and the emitted smoke is harmful to the environment. Moreover, in this method, the smoked food product needs to be secondarily packaged in another barrier casing, and thus the method is not efficient.

The international publication pamphlet No. WO98/31731 discloses, instead of actually using smoke for smoke-curing a food product, packaging a food product in a film, to which a smoke-curing liquid has been applied, so that the smoke-curing liquid is transferred to the food product.

This method, however, is disadvantageous in the following points: the coating liquid containing a smoke-curing agent lacks flexibility because its formula is limited to one determined in accordance with the properties of a first layer film (a composition comprising an additive, a cross linking agent and a binder). In addition, the desired smoke-curing treatment cannot be achieved since the smoke-curing agent is not uniformly and sufficiently held in the first layer. Moreover, the shape of the first film is limited to a tubular form obtained by sealing a flat film into a tube form, wherein poor shrinkage is likely to occur in the sealing portion.

### SUMMARY OF THE INVENTION

The invention aims to provide a multilayer tube for transferring a smoke-curing liquid to food that makes it possible to sufficiently smoke-cure a food product, such as meat and the like, by packaging the food product in the tube. More specifically, the invention aims to provide a multilayer tube for transferring a smoke-curing liquid to food that can impart to the food product a favorable smoke flavor, smoke color, and smoke taste. Moreover, the invention aims to provide a food product packaged in the multilayer tube for transferring a smoke-curing liquid to food and a method for producing a smoked food product using the multilayer tube for transferring a smoke-curing liquid to food.

The inventors carried out intensive research in order to overcome the above-described problems of the prior art, and as a result found that a smoke-cured treatment can be sufficiently carried out by packaging a food product, such as meat and the like, in a multilayer tube for transferring a smoke-curing liquid to food. The tube has an innermost layer which comprises a polyamide resin and a crosslinked polyvinylpyrrolidone and to which a smoke-curing liquid is applied. The inventors conducted further research and accomplished the present invention based on these findings.

More specifically, the present invention provides the following multilayer tubes for transferring a smoke-curing liquid to food, packaged food products wherein a food product is packaged in the multilayer tube for transferring a smoke-curing liquid to food, and methods for producing smoke-cured food products using the multilayer tube for transferring a smoke-curing liquid to food.

### Item 1. A multilayer tube for transferring a smoke-curing liquid to food, the tube having an innermost layer comprising a polyamide resin and a crosslinked polyvinylpyrrolidone.

### Item 2. A multilayer tube for transferring a smoke-curing liquid to food according to Item 1, the tube having at least three layers.

### Item 3. A multilayer tube for transferring a smoke-curing liquid to food according to Item 1 or 2, wherein the tube has been subjected to a corona discharge.

### Item 4. A multilayer tube for transferring a smoke-curing liquid to food according to any one of Items 1 to 3, wherein the tube has the innermost layer applied with a smoke-curing liquid.

Item 5. A multilayer tube for transferring a smoke-curing liquid to food according to any one of Items 1 to 4, wherein the crosslinked polyvinylpyrrolidone is present in the innermost layer in a proportion of about 1 to about 50% by weight, relative to the content of the polyamide resin.

### Item 6. A multilayer tube for transferring a smoke-curing liquid to food according to any one of Items 1 to 5, wherein the tube has at least one vapor barrier layer as an outer layer for the innermost layer.

### Item 7. A multilayer tube for transferring a smoke-curing liquid to food according to any one of Items 1 to 5, wherein the tube has at least one oxygen barrier layer as an outer layer for the innermost layer.

### Item 8. A multilayer tube for transferring a smoke-curing liquid to food according to any one of Items 1 to 5, wherein the tube has at least one vapor barrier layer and at least one oxygen barrier layer as outer layers over the innermost layer.

### Item 9. A multilayer tube for transferring a smoke-curing liquid to food according to any one of Items 1 to 8, wherein the innermost layer, the at least one oxygen barrier layer and the at least one oxygen barrier layer are disposed in this order.

### Item 10. A multilayer tube for transferring a smoke-curing liquid to food according to Item 8 or 9, wherein the vapor barrier layer comprises an olefin-based polymer and the oxygen barrier layer comprises a polyamide resin.

### Item 11. A multilayer tube for transferring a smoke-curing liquid to food according to Item 8, wherein

the innermost layer A comprises a polyamide resin and a crosslinked polyvinylpyrrolidone,

the vapor barrier layer B, B₁ or B₂ comprises an olefin-based polymer, the layers B₁ and B₂ comprising a different olefin-based polymer, and

the oxygen barrier layer C comprises a polyamide resin,

these layers being disposed in the following order:
A/B/C,
A/B₁/B₂/C,
A/B₁/B₂/B₁/C,
A/B₁/C/B₁/C, or
A/C/B/C.

### Item 12. A packaged food product, wherein a food product is packaged in the multilayer tube for transferring a smoke-curing liquid to food of Item 4.

Item 13. A method for producing a smoked food product comprising:

packaging a food product into the multilayer tube for transferring a smoke-curing liquid to food of Item 4; and

heating the food product packaged in the multilayer tube.

### DETAILED DESCRIPTION OF THE INVENTION

Hereinafter, the present invention is described in detail.

### Multilayer Tube for Transferring a Smoke-Curing Liquid to Food

The multilayer tube for transferring a smoke-curing liquid to food of the invention refers to a tube that is capable of holding a smoke-curing liquid therein, and that is capable of transferring the smoke-curing liquid to a food product, such as meat and the like. The multilayer tube of the invention has a cylindrical or annular form and has an innermost layer comprising a polyamide resin and crosslinked polyvinylpyrrolidone (PVPP). In particular, the multilayer tube has at least three layers, including the innermost layer. The multilayer tube is used as a heat-shrinkable casing (film) for smoke-curing a food product or the like, and has excellent shrinkage properties due to being seamless.

The casing for use in smoke-curing a food product produced from the multilayer tube of the invention has a polyamide resin and crosslinked polyvinylpyrrolidone in the innermost layer. Therefore, when the inside of this casing is treated with a smoke-curing liquid, a sufficient amount of the smoke-curing agent can be uniformly held therein. Thereafter, a food product such as meat or the like is packaged into the casing and then subjected to a heat treatment (e.g., cooking, etc.). Thus, the smoke-curing agent is uniformly and sufficiently transferred to the food product, and thereby a high-quality smoked food product is easily provided.

Examples of a polyamide resin forming the innermost layer include Nylon 6, Nylon 66, Nylon 610, Nylon 11, Nylon 12, MXD nylon (polymetaxylylene adipamide), copolymers thereof, etc. These compounds may be used singly or as a mixture thereof.

The crosslinked polyvinylpyrrolidone that forms the innermost layer is a cross-linked polymer of N-vinylpyrrolidone, wherein moisture can be absorbed in an amount of about 1 to 30 times its own weight and the absorbed moisture can also be released. Moreover, the crosslinked polyvinylpyrrolidone has a stable water absorption capacity for aqueous salt solutions with various concentrations and for wide pH ranges.

The crosslinked polyvinylpyrrolidone content in the innermost layer may be about 1 to about 50% by weight, preferably about 10 to about 20% by weight, and more preferably about 13 to about 18% by weight, relative to the polyamide resin content. By selecting this range, the smoke-curing agent can be sufficiently held in the multilayer tube (innermost layer).

Preferably, at least one vapor barrier layer is provided as an outer layer over the innermost layer. This is because the vapor barrier layer can prevent food deterioration and weight reduction of the end packaged food product due to moisture permeation. Olefin polymers can be mentioned as a vapor barrier layer. Examples of olefin polymers include homopolymers of olefin (e.g., ethylene, propylene, butene, etc.); mutual copolymers thereof; copolymers of these olefins and other copolymerizable monomers(e.g., vinyl-based monomers such as (metha) acrylic acid, (metha) acrylate, metal salts thereof, etc.); modified polymers thereof; etc. Specific examples include polyethylene (e.g., LDPE, LLDPE, etc.), polypropylene, polybutene, mutual copolymers thereof, ionomer resins, ethylene acrylic acid copolymers, ethylene vinyl acetate copolymers, modified polyolefine resins, etc.

Here, mentioned as a typical example of modified polyolefine resins are modified polymers wherein unsaturated carboxylic acids (e.g., maleic acid, fumaric acid, etc.) or derivatives thereof (e.g., acid anhydride, such as maleic acid or the like, ester, or metal salts, etc.) have been copolymerized (e.g., using graft copolymerization) with the above-mentioned homopolymers or copolymers of olefins. Moreover, as examples of modified polyolefin resins, the above-mentioned modified polymers can be used singly or in a mixture of two or more kinds, or a mixture of the modified polymer(s) and one or more ingredients (e.g., other polyolefin resins) can also be mentioned. In particular, maleic anhydride modified polyethylene and maleic anhydride modified polypropylene are mentioned.

Preferably, at least one oxygen barrier layer is provided as an outer layer over the innermost layer. This is because the oxygen barrier layer can inhibit oxygen permeation, thereby preventing oxidation and putrefaction of food products. The above-mentioned polyamide resins for preparing the innermost layer are similarly used for the preparation of the oxygen barrier layer, and specific examples thereof include Nylon 6, Nylon 66, Nylon 610, Nylon 11, Nylon 12, MXD nylon (polymetaxylylene adipamide), copolymers thereof, etc. These compounds may be used singly or as a mixture thereof. Moreover, the above-mentioned oxygen barrier layer also functions as a layer for maintaining the strength of the multilayer tube.

The multilayer tube for transferring a smoke-curing liquid to food of the invention has preferably at least three layers, including an innermost layer comprising a polyamide resin and crosslinked polyvinylpyrrolidone. The multilayer tube can be structured in various combinations of layers, and preferably, at least one vapor barrier layer and at least one oxygen barrier layer are formed outside the innermost layer as an outer layer. The oxygen barrier layer is provided preferably as an outermost layer of the multilayer tube. For example, an innermost layer, at least one vapor barrier layer and an oxygen barrier layer are formed in this order. Specific examples of preferable combinations of the multilayer tube include the following:
A/B/C,
A/B₁/B₂/C,
A/B₁/B₂/B₁/C,
A/B₁/C/B₁/C, and
A/C/B/C.
A: An innermost layer comprising a polyamide resin and crosslinked polyvinylpyrrolidone,
B: A vapor barrier layer comprising an olefin polymer (B₁ and B₂ are vapor barrier layers each comprising a different olefin polymer),
C: An oxygen barrier layer comprising a polyamide resin.

Among the above-mentioned combinations, it is more preferable that A and C are the same as above, and B is a vapor barrier layer comprising maleic anhydride modified polyethylene, maleic anhydride modified polypropylene, etc.

Another preferable combination is such that A and C are the same as above, and B₁ is a vapor barrier layer comprising maleic anhydride modified polyethylene, maleic anhydride modified polypropylene, or the like, and B₂ is a vapor barrier layer comprising polypropylene, a low density polyethylene (LDPE), a linear low density polyethylene (LLDPE), or the like. The polyamide resin of A and C may be the same or different.

The thickness of the multilayer tube for transferring a smoke-curing liquid to food of the invention is, for example, as follows: the innermost layer is about 3 μm to about 20 μm (preferably about 5 μm to about 15 μm); the thickness of the vapor barrier layer is about 3 μm to about 20 μm (preferably about 5 μm to about 15 μm) and the thickness of the oxygen barrier layer is about 5 μm to about 40 μm (preferably about 10 μm to about 35 μm). Even when two or more vapor barrier layers and oxygen barrier layers are provided, the total thickness of the layers is preferably within the above ranges.

By the use of the above-described multilayer tube, since the smoke-curing liquid can be dominantly retained in the innermost layer, a food product, such as meat is effectively smoked and, moreover, since the entry of vapors and/or oxygen can be blocked, the storage stability of the smoked food is improved.

### Smoke-Curing Liquid

A smoke-curing liquid is applied to the innermost layer of the multilayer tube for transferring a smoke-curing liquid to food of the invention, when the multilayer tube is used as a casing for smoke-curing a food product, etc. There is no limitation on the smoke-curing liquid, and any known smoke-curing liquids can be used.

The smoke-curing liquid is an aqueous solution comprising components, such as a colorant, viscosity modifier, and surfactant.

Preferably, for cook-in applications (i.e., where a food product is cooked while being packaged in a film), the colorant is of a type that reacts with proteins in a food product by the Maillard reaction. Compounds that react with proteins in this manner are active carbonyl compounds such as hydroxyacetaldehdye and reducing sugars such as fructose, glucose, ribose, lactose, xylose and the like.

Examples of a Maillard reaction type colorant include “Maillose” (trade name), which is available from Red Arrow. The use of this type of colorant can impart a brown color to a food product without adversely affecting its flavor by a thermal reaction with the protein contained in meat. “Maillose” is formed from the pyrolysis of sugars and starches.

Liquid smoke is preferable as a colorant and is a condensate of products collected from the pyrolysis of wood or cellulose. An example is liquid smoke available from Red Arrow under the trade name “CharSol PN-9”.

Examples of viscosity modifiers include chitosan, polysaccharides, derivatives of starch, and derivatives of cellulose. Specifically, methyl cellulose, carboxymethylcellulose, etc., can be mentioned and, for example, “Methocel SGA16M” manufactured by The Dow Chemical company, etc., is preferable as methyl cellulose.

Examples of surfactants include monoglycerides, propylene glycols, sodium lauryl sulfate, etc.

The composition of the smoke-curing liquid used in the invention is not limited, and, for example, the content of the surfactant may be about 3.0 to about 8.0% by weight and the viscosity modifier may be about 0.05 to about 0.5% by weight, relative to the content of the colorant. Specifically, propylene glycol (a surfactant) may be present in a proportion of about 4.0 to about 7.0% by weight and methyl cellulose (a viscosity modifier) may be present in a proportion of about 0.07 to about 0.3% by weight, relative to the content of the liquid smoke (a colorant).

The concentration of the smoke-curing liquid can be suitably determined according to the intended use, and the smoke-curing liquid can further comprise, if required, flavors (fragrances, odorants, etc.) and other ingredients.

### Method for Producing a Multilayer Tube for Transferring a Smoke-Curing Liquid to Food

The multilayer tube for transferring a smoke-curing liquid to food of the invention has at least three layers: an innermost layer comprising a polyamide resin and crosslinked polyvinylpyrrolidone; a vapor barrier layer, and an oxygen barrier layer. The multilayer tube is formed by an inflation molding method, etc., using resins for forming each of the innermost layer, the vapor barrier layer, and the oxygen barrier layer. The multilayer tube is stretched using a known procedure, and, for example, can be obtained by biaxially stretching a tube about 1 to about 5 times (preferably about 2.5 to about 3.5 times) its initial length in the longitudinal direction and about 1 to about 5 times (preferably about 2.5 to 3.5 times) its initial width in the transverse direction. The biaxial stretching may be conducted simultaneously or sequentially. The multilayer tube thus obtained is a seamless multilayer tube with no joint, and thus exhibits a uniform shrinkage property.

In order to improve the contact between the tube and the packaged substance, such as processed meat or the like, the multilayer tube is preferably subjected to a corona discharge treatment after it is stretched. Specifically, the multilayer tube is subjected to a corona discharge as follows: a gas is sealed inside the multilayer tube; the multilayer tube is positively pressed avoiding the mutual contact of opposed surface areas of innermost layer; and at least two pairs of electrodes are arranged in a specific manner to conduct a corona discharge from the outside of the tube. The corona discharge allows the wetting tension of the innermost layer surface of the multilayer tube to be improved and the discharge to be conducted approximately uniformly, whereby the contact between the tube and the processed meat is improved. Specifically, the corona discharge can be conducted by following the procedure disclosed in Japanese Patent No. 2678299.

Preferably, this corona discharge is conducted so that the wetting tension of the innermost layer surface is 42 dynes/cm or higher, preferably 45 dynes/cm or higher, and more preferably 50 to 60 dynes/cm. The conditions of the corona discharge are not limited and may be suitably determined according to the type, thickness, and feeding rate of the film to be processed.

Then, a smoke-curing liquid is applied to the innermost layer of the multilayer tube for transferring the smoke-curing liquid to food of the invention. There is no limitation to the coating procedure, and, for example, the method may comprise: packaging a smoke-curing liquid into the multilayer tube; sandwiching the multilayer tube between a pair of coating rolls to press out any smoke-curing liquid that is unevenly distributed in the multilayer tube; and thus the smoke-curing liquid permeates and is absorbed into the inner layer of the casing. Thus, the smoke-curing liquid can be uniformly and efficiently applied to the innermost layer of the multilayer tube.

Specifically, the following procedures can be employed. (1) The multilayer tube is slit open and the smoke-curing liquid to be applied is added. (2) Air is injected to form the multilayer tube into a cylindrical shape and the slit is sealed with a tape. (3) The tube is advanced through a pair of coating rolls. As the multilayer tube with the smoke-curing liquid passes through the rolls, most of the liquid is squeezed out to be applied to the innermost layer of the multilayer tube. The spacing between the coating rolls is adjustable so that the rolls are not totally closed. (4) The multilayer tube with the smoke-curing liquid absorbed into the inside surface is then wound onto reels.

Thus, the multilayer tube for transferring a smoke-curing liquid to food of the invention is manufactured.

### Method for Producing a Smoked Food Product

The invention provides a packaged food product wherein the food product is packaged in the above-described multilayer tube for transferring a smoke-curing liquid to food as a casing for smoking. The invention also provides a method for producing a smoked food product, comprising packaging a food product into the multilayer tube for transferring a smoke-curing liquid to food, and heating the resultant food product.

Examples of food products to be packaged in the casing of the invention include ham, sausage, bacon, beef, turkey, and like meat-processed food products; fish meat processed-goods; kamaboko (steamed fish paste), chikuwa (baked fish paste), and like fish paste products; cheeses; etc.

The above-described multilayer tube for transferring a smoke-curing liquid to food can be cut to a desirable length in accordance with the size of the food to be packaged, and can be used, as such, as a casing for smoking, or as a bag-like object. As a manner of packaging a food product in a casing for smoking, a food product may be packaged into the casing for smoking and sealed.

The packaged food product can be cooked or heated under known conditions without limitation. As an example, the conditions for a ham sausage food product are mentioned below.

A packaged ham sausage is heated so that the central temperature thereof reaches about 71° C. to about 75° C. The packaged ham sausage may be heated by any suitable method, and, for example, may be boiled, heated by steam, placed in an oven, or subjected to electromagnetic waves, etc. Thus, the smoked food product of the invention is produced.

### BEST MODE FOR CARRYING OUT THE INVENTION

Hereinafter, the present invention is described in more detail with reference to Examples, but is not limited thereto. In the following Examples, unless otherwise specified, “part” means “part by weight”.

### EXAMPLE 1

Through a three-layered circular die were coextruded an outer layer, a Nylon 6-66 copolymer resin (trade name “5034FDX41”, a product of Ube Industries, Ltd.); an intermediate layer, a maleic anhydride modified polyethylene (trade name “PF508”, a product of Mitsui Chemicals, Inc.); and an innermost layer, 84 parts of Nylon 6 (trade name, “1022FDY2”, a product of Ube Industries, Ltd.) and 16 parts of crosslinked polyvinylpyrrolidone (trade name “Polyplasdone XL10”, a product of ISP Technologies.), to thereby form a tubular film. The tubular film was simultaneously stretched biaxially 2.5 times and 3.0 times its initial length in the longitudinal length and width in the transverse direction, respectively, to form a three-layered tubular film, wherein the thickness of the outer layer, intermediate layer and innermost layer were 15 μm, 10 μm, and 10 μm, respectively and the total thickness was 35 μm. Corona discharge was then performed using a device of Japanese Patent No. 2678299 according a method thereof. The wetting tension (dyne level) of the inner surface of the tube was 52 dynes/cm.

A smoke-curing liquid comprising 5.2 wt % of propylene glycol (a surfactant), and 0.1 wt % of “Methocel SGA16M” (a viscositymodifier) relative to the content of liquid smoke (trade name “CharSol PN-9”, a product of Red Arrow) was used. According to the method as described above, the smoke-curing liquid was packaged into the multilayer tube; the multilayer tube was sandwiched between a pair of coating rolls to press out any smoke-curing liquid that was unevenly distributed in the multilayer tube; and thus the smoke-curing liquid permeated and was absorbed into the inner layer of the casing, providing the casing of the invention.

About 24 hours later, even though the surface coated with the smoke-curing liquid was wiped with a dry cloth, the smoke-curing liquid was not wiped off. It was found that the inner layer coated with the smoke-curing liquid was not sticky, and that the crosslinked polyvinylpyrrolidone (PVPP) was sufficiently absorbed and held in the inner layer.

### COMPARITIVE EXAMPLE 1

A three-layered tubular film was prepared in a manner similar to that of Example 1 except that Nylon 6 only was used (comprising no crosslinked polyvinylpyrrolidone) as the innermost layer. The wetting tension (dyne level) of the inner surface of the film after the corona treatment was 52 dynes/cm.

The same smoke-curing liquid as in Example 1 was applied to the inside of the multilayer tube, providing a casing for smoking. About 24 hours later, the surface coated with the smoke-curing liquid was wiped with a dry cloth, and the smoke-curing liquid was easily wiped off.

### TEST EXAMPLE 1

Ham was packaged into the casing of Example 1. The smoke-curing liquid uniformly covered the ham surface without being removed from the innermost layer of the casing.

Similarly, ham was packaged into the casing of Comparative Example 1. Most of the smoke-curing liquid applied was removed from the innermost layer of the casing while it was kneaded into the ham due to the frictional force caused when the ham was packaged into the casing, and thus the liquid merely remained in the ham surface in a streaky pattern.

Thereafter, each of the ham-packed casings of Example 1 and Comparative Example 1 was treated in hot water of 75° C. for 2 hours, providing smoked hams.

In the smoked-ham prepared using the casing of Example 1, a smoke color was uniformly applied to the ham surface and a smoke flavor was also transferred thereto. The smoked-ham surface was moderately dried and a smoke-colored skin layer was formed.

In contrast, the smoked-ham prepared using the casing of Comparative Example 1 had the following disadvantages: the ham surface was colored in a streaky pattern; most of the portion where no smoke-curing liquid remained was not colored; and the surface was not dried. Thus, the commercial value as smoked ham was remarkably low.

### EFFECT OF THE INVENTION

With the use of the multilayer tube for transferring a smoke-curing liquid to food of the invention as a casing for smoking, a favorable smoke flavor, color, and taste can be imparted to a food product. Moreover, since the multilayer tube for transferring a smoke-curing liquid to food of the invention has high strength and low permeability of vapor and/or oxygen, a food product packaged therein exhibits excellent storage stability. Since the smoke-curing liquid applied uniformly covers the food surface without being removed from the innermost layer of the casing, the food surface is uniformly imparted with a smoke color. Thus, the multilayer tube for transferring a smoke-curing liquid to food of the invention provides a smoked food product with a high-quality appearance.

Moreover, the invention can provide a high-quality packaged food product wherein the food product has been packaged in the multilayer tube for transferring a smoke-curing liquid to food of the invention and a method for producing a smoked food using the multilayer tube for transferring a smoke-curing liquid to food.

1. A multilayer tube for transferring a smoke-curing liquid to food, the tube having an innermost layer comprising a polyamide resin and a crosslinked polyvinylpyrrolidone.

2. A multilayer tube for transferring a smoke-curing liquid to food according to claim 1, the tube having at least three layers.

3. A multilayer tube for transferring a smoke-curing liquid to food according to claim 1, wherein the tube has been subjected to a corona discharge.

4. A multilayer tube for transferring a smoke-curing liquid to food according to claim 1, wherein the tube has the innermost layer applied with a smoke-curing liquid.

5. A multilayer tube for transferring a smoke-curing liquid to food according to claim 1, wherein the crosslinked polyvinylpyrrolidone is present in the innermost layer in a proportion of about 1 to about 50% by weight, relative to the content of the polyamide resin.

6. A multilayer tube for transferring a smoke-curing liquid to food according to claim 1, wherein the tube has at least one vapor barrier layer as an outer layer for the innermost layer.

7. A multilayer tube for transferring a smoke-curing liquid to food according to claim 1, wherein the tube has at least one oxygen barrier layer as an outer layer for the innermost layer.

8. A multilayer tube for transferring a smoke-curing liquid to food according to claim 1, wherein the tube has at least one vapor barrier layer and at least one oxygen barrier layer as outer layers over the innermost layer.

9. A multilayer tube for transferring a smoke-curing liquid to food according to claim 1, wherein the innermost layer, the at least one oxygen barrier layer and the at least one oxygen barrier layer are disposed in this order.

10. A multilayer tube for transferring a smoke-curing liquid to food according to claim 8, wherein the vapor barrier layer comprises an olefin-based polymer and the oxygen barrier layer comprises a polyamide resin.

11. A multilayer tube for transferring a smoke-curing liquid to food according to claim 8, wherein
the innermost layer A comprises a polyamide resin and a crosslinked polyvinylpyrrolidone,
the vapor barrier layer B, B₁ or B₂ comprises an olefin-based polymer, the layers B₁ and B₂ comprising a different olefin-based polymer, and
the oxygen barrier layer C comprises a polyamide resin,
these layers being disposed in the following order:
A/B/C,
A/B₁/B₂/C,
A/B₁/B₂/B₁/C,
A/B₁/C/B₁/C, or
A/C/B/C.

12. A packaged food product, wherein a food product is packaged in the multilayer tube for transferring a smoke-curing liquid to food of claim 4.

13. A method for producing a smoked food product comprising:
packaging a food product into the multilayer tube for transferring a smoke-curing liquid to food of claim 4; and heating the food product packaged in the multilayer tube.
